(19) United States
(12) Patent Application Publication
(10) Pub. No.: US 2003/0073429 A1
(43) Pub. Date: Apr. 17, 2003

(54) Method of searching telephone number

(76) Inventor: Yong-Sub Lim, Sungnam-si (KR)

Correspondence Address: McGuireWoods LLP, Suite 1800, 1750 Tysons Boulevard, McLean, VA, 22102, US

(21) Appl. No.: 10/265,187

(22) Filed: Oct. 7, 2002

(30) Foreign Application Priority Data
Oct. 15, 2001 (KR) 2001-63381

(51) Int. Cl. H04M 3/42

(52) U.S. Cl. 455/414; 455/566

(57) ABSTRACT

A method of searching a telephone number is disclosed, in which when a user desires to communicate with a third party using a personal communication service unit such as a cellular phone, the user can easily dial a desired telephone number by efficiently searching telephone numbers input to the personal communication service unit. The method includes the steps of inputting a telephone number through a telephone number input means, storing the input telephone number in a memory and at the same time outputting a group of telephone numbers, which share some digits of the input telephone number, from the memory and displaying the group of telephone numbers on a display window depending on the digits of the input telephone number, and selecting at least one telephone number from the group of the telephone numbers displayed on the display window so as to dial the selected telephone number.

### BACKGROUND OF THE INVENTION

1. Field of the Invention

The present invention relates to a method of searching a telephone number, and more particularly to a method of searching a telephone number, in which when a user desires to communicate with a third party using a personal communication service unit such as a cellular phone, the user can easily dial a desired telephone number by efficiently searching telephone numbers input to the personal communication service unit.

2. Discussion of the Related Art

Generally, a related art cellular phone is constructed in such a manner that a user communicates with a third party by means of two methods. In one method, the user inputs all digits of a telephone number one by one. In the other method, the user searches a desired telephone number from telephone numbers previously stored in a telephone memory and pushes a call button to dial the searched telephone number.

The one method of inputting all digits of a telephone number one by one has drawbacks in that the user must remember a telephone number and input all of digits of a telephone number. In general, since the user tends to use a small number of telephone numbers, this method causes the user to feel inconvenience.

The other method of dialing a telephone number by searching the telephone number stored in a telephone memory requires the user to check search addresses having telephone numbers stored therein one by one. In this case, a problem arises in that it takes much time to search the telephone numbers.

### SUMMARY OF THE INVENTION

The present invention is directed to a method of searching a telephone number that substantially obviates one or more of the problems due to limitations and disadvantages of the related art.

An object of the present invention is to provide a method of searching a telephone number in which data input by a user are automatically stored in a telephone memory so that a group of telephone numbers including digits of a telephone number input by the user among the data stored in the telephone memory is displayed on a display window if the user inputs the digits of the telephone number.

Another object of the present invention is to provide a method of searching a telephone number in which a user can dial a small number of frequently used telephone numbers within a short time by easily searching the telephone numbers.

Other object of the present invention is to provide a personal communication service unit for convenient use that can dial a desired telephone number by inputting some digits of the telephone number.

Supposing that a telephone number has seven digits and its first digit is input, a group of telephone numbers corresponding to the first digit is output from a telephone memory and is displayed on a display window. If the displayed group of telephone numbers does not include the user's desired telephone number, the user inputs the second digit of the telephone number so that a group of telephone numbers including the first and second digits is output again from the telephone memory and then is displayed on the display window. In a state where the user inputs the two digits of the telephone number, if the group of the telephone numbers displayed on the display window includes the user's desired telephone number, the user directly moves a cursor without inputting the other digits of the telephone number so as to click the desired telephone number, thereby dialing the desired telephone number.

If the user's desired telephone number is not displayed on the display window in spite of the fact that the user inputs seven digits of the telephone number, the telephone memory regards the telephone number as a new one and automatically stores the telephone number therein.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, in a method of searching a telephone number of a personal communication service unit having a telephone number input means, a memory for storing telephone numbers input from the telephone number input means, a display window for displaying a telephone number selected from the telephone numbers stored in the memory, the method includes the steps of inputting a telephone number through the telephone number input means, storing the input telephone number in the memory and at the same time outputting a group of telephone numbers, which share some digits of the input telephone number, from the memory and displaying the group of telephone numbers on the display window depending on the digits of the input telephone number, and selecting at least one telephone number from the group of the telephone numbers displayed on the display window so as to dial the selected telephone number.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a block diagram illustrating a personal communication service unit according to the present invention;

FIG. 2 is a flow chart illustrating a method of searching a telephone number of a personal communication service unit according to the present invention; and

FIGS. 3a to 3d are flow charts illustrating a procedure of searching a telephone number according to the present invention.

### DETAILED DESCRIPTION OF THE PREFERRED EMBODIMENTS

Reference will now be made in detail to the preferred embodiments of the present invention, examples of which are illustrated in the accompanying drawings.

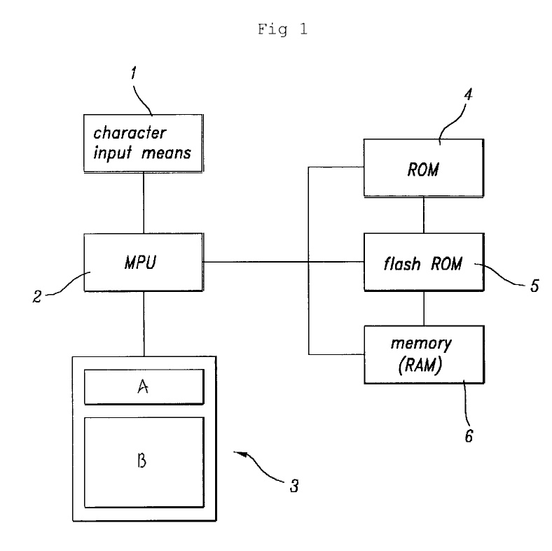

The construction and operation according to the present invention will be described with reference to FIGS. 1 to 3.

A personal communication service unit, as shown in FIG. 1, includes a microprocessor processing unit (MPU) 2, a read only memory (ROM) 4, a flash ROM 5, and a random access memory (RAM) 6. A real time clock and a controller of a display window 3 are built in the MPU 2. The ROM 4 stores an operating system, a basic program, and font image data. The flash ROM 5 stores a downloaded program or a database. The RAM 6 loads a program to implement the program stored in the flash ROM 5 and allocates a system memory area used to implement the operating system and a dynamic memory required to implement the program.

The personal communication service unit further includes a liquid crystal display (LCD) window 3 on which characters or figures are displayed by implementing a telephone dialing program, and a character input means 1 having a key board.

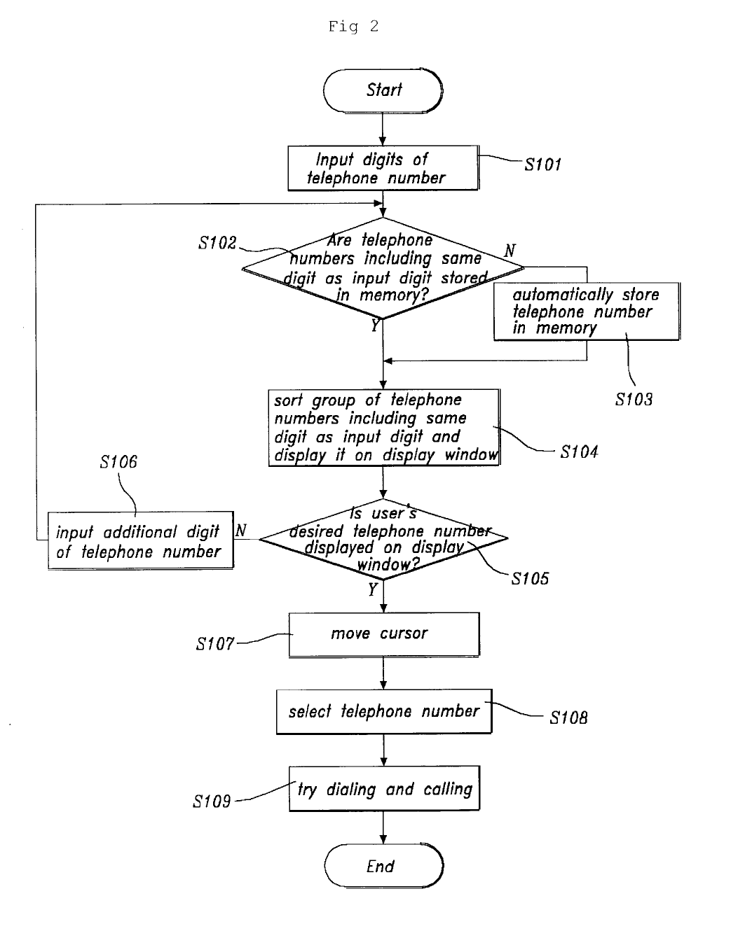

In the present invention, when a user dials a telephone number using the aforementioned personal communication service unit, a program for a method of searching a telephone number, in which a desired telephone number can be dialed by an efficient search system, is input to the flash ROM 5. The method of searching a telephone number based on the program will be described with reference to a flow chart of FIG. 2.

The first digit of a telephone number which a user desires to dial is input to ‘A’ of the display window 3 using the character input means 1 in step S101.

The flash ROM 5 and the MPU 2 are driven to search whether a group of telephone numbers having the same digit as the first digit input by the user is stored in the RAM 6 in step S102. When the group of telephone numbers is stored in the RAM 6, it is sorted and displayed on ‘B’ of the display window 3 in step S104.

Meanwhile, when the group of telephone numbers is not stored in the RAM 6, the telephone number input by the user is regarded as a new one and is stored in the RAM 6 in step S103.

Subsequently, the user determines whether there is a desired telephone number in the group of telephone numbers displayed on ‘B’ of the display window 3 in step S105. If the desired telephone number is displayed on ‘B’ of the display window 3, the user moves a cursor 7 to the corresponding telephone number in step S107 so as to select the telephone number in step S108. Then, the user pushes a call button to try calling in step S109.

If the desired telephone number is not displayed on the display window in step S105, the user additionally inputs the second digit of the telephone number to ‘A’ of the display window in step S106. The step S102 is then repeated.

If the desired telephone number has already input to the RAM 6, the probability that the desired telephone number will be displayed on the display window increases as the user additionally inputs the next digits of the telephone number to ‘A’ of the display window. Accordingly, the user can easily search and dial the desired telephone number by inputting first some digits of the telephone number.

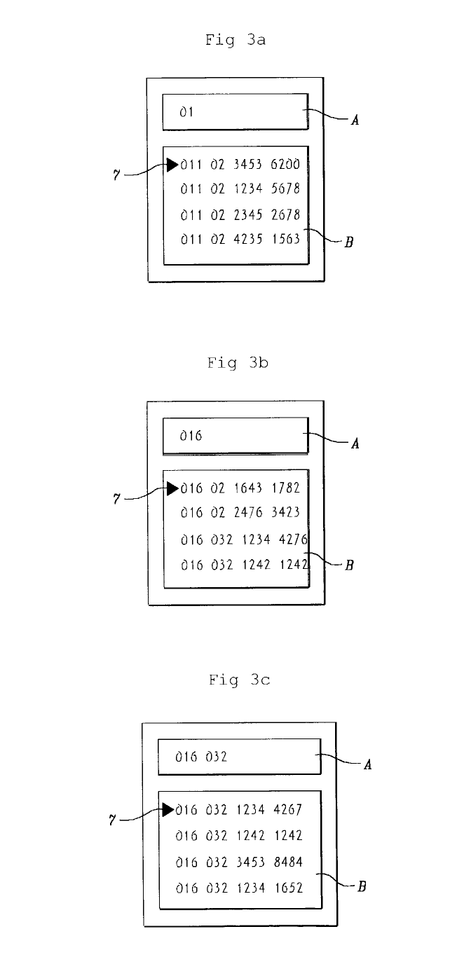

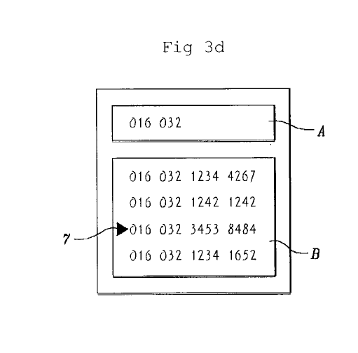

The method of searching a telephone number will be described in more detail with reference to FIGS. 3a to 3d.

As shown in FIG. 3a, if the user inputs ‘01’ to ‘A’ of the display window 3, the group of telephone numbers sharing ‘01’ among the telephone numbers stored in the RAM 6 is displayed on ‘B’ of the display window 3. In FIG. 3, four telephone numbers are displayed on the display window.

At this time, the cursor 7 is positioned at the side of the telephone number displayed on the top.

Subsequently, as shown in FIG. 3B, if the user additionally inputs number ‘6’ next to ‘01,’ a group of telephone numbers sharing ‘016’ is displayed on ‘B’ of the display window.

If no desired telephone number exists in the group of telephone numbers sharing ‘016,’ the user additionally inputs the next digits ‘032.’ Then, as shown in FIG. 3c, a group of telephone numbers sharing ‘016032’ is displayed on the display window.

Supposing that 016-032-3453-8484 in the group of telephone numbers is the user's desired telephone number, the user moves the cursor 7 to the corresponding telephone number and pushes the call button to complete dialing of the telephone number.

While the method of searching a telephone number according to the present invention has been described based on the method of inputting digits of a telephone number, the object of the present invention may be achieved even by a method of inputting a name using Korean or English characters.

As aforementioned, the method of searching a telephone number according to the present invention has the following advantages.

First, the user can easily search a desired telephone number by directly inputting some digits of the telephone number without separately searching data stored in the memory.

In addition, the user can dial a small number of frequently used telephone numbers within a short time by easily searching the telephone numbers.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of searching a telephone number of a personal communication service unit having a telephone number input means, a memory for storing telephone numbers input from the telephone number input means, a display window for displaying a telephone number selected from the telephone numbers stored in the memory, the method comprising the steps of:
inputting a telephone number through the telephone number input means;
storing the input telephone number in the memory and at the same time outputting a group of telephone numbers, which share some digits of the input telephone number, from the memory and displaying the group of telephone numbers on the display window depending on the digits of the input telephone number; and
selecting at least one telephone number from the group of the telephone numbers displayed on the display window so as to dial the selected telephone number.
